(19) United States
(12) Patent Application Publication
(10) Pub. No.: US 2025/0334662 A1
(43) Pub. Date: Oct. 30, 2025

(54) POSITIONING SYSTEM IN MULTIPATH ENVIRONMENT USING CHIRP SIGNAL

(71) Applicant: OWLYNK CO., LTD., Suwon-si (KR)

(72) Inventor: Shin Hwan HWANG, Yongin-si (KR)

(73) Assignee: OWLYNK CO., LTD., Suwon-si (KR)

(21) Appl. No.: 19/193,774

(22) Filed: Apr. 29, 2025

(30) Foreign Application Priority Data
Apr. 30, 2024 (KR) 10-2024-0057676

(51) Int. Cl. G01S 5/02; G01S 5/06

(52) U.S. Cl. CPC G01S 5/0218; G01S 5/0221; G01S 5/0226; G01S 5/06

(57) ABSTRACT

A radio frequency signal transmitted from a transmit antenna is received to measure a departure angle, which is an angular position from the transmit antenna as viewed from a receive antenna, and a position of a wireless receiver is estimated using a position of a wireless transmitter, whose position is known, and a departure angle from this transmitter.

### CROSS-REFERENCE TO RELATED APPLICATION(S)

This application claims priority from Korean Patent Application No. 10-2024-0057676, filed on Apr. 30, 2024, in the Korean Intellectual Property Office, the disclosure of which is incorporated herein by reference in its entirety.

### BACKGROUND OF THE INVENTION

### Field of the Invention

The present invention relates to positioning technology, and more particularly to technology for determining a position of a receiver by estimating a departure angle for a selected line-of-sight (LOS) signal in a multipath environment such as an indoor environment.

### Description of the Related Art

An indoor positioning system determines a position indoors by various positioning methods using wireless communication after installing anchor nodes such as base stations, Wi-Fi access points, and UWB anchors.

Indoor positioning technology uses trilateration or fingerprinting to determine a position. Trilateration uses at least three anchors (transmitters) whose positions are known as reference points to determine a position using a distance to each anchor, and fingerprinting is technology that creates a radio map by mapping strength of signals coming from several anchors onto an indoor map and then determines a position using a matching algorithm that searches the radio map for a pattern of signal strength measured at a specific position.

When the number of installed anchors is increased, more precise positioning is possible. However, this causes a problem of increased costs.

In addition, in a multipath environment such as indoors, there is a problem in that accuracy of estimation deteriorates since a receiver receives overlapping signals due to reflection or multiple reflections from walls or obstacles.

### SUMMARY OF THE INVENTION

It is an object of the present invention to provide a positioning system capable of estimating a departure angle of a signal transmitted by a transmitter with high accuracy in a multipath environment.

It is another object of the present invention to provide a positioning system capable of determining a position of a receiver using at least two transmitters in a multipath environment.

A positioning system according to an aspect of the present invention is a system that determines a position in a multipath environment using a chirp signal, and the positioning system includes a first wireless transmitter, a second wireless transmitter, and a wireless receiver. The first wireless transmitter sequentially drives a plurality of transmit antennas arranged at regular intervals according to an arrangement order thereof to transmit the same first chirp signals.

The second wireless transmitter sequentially drives a plurality of transmit antennas arranged at regular intervals according to an arrangement order thereof to transmit the same second chirp signals.

The wireless receiver includes a line-of-sight (LOS) signal selection unit configured to select an LOS signal based on a bit frequency of each path detected by processing signals in the multipath environment received through a receive antenna, an IQ demodulation unit configured to IQ-demodulate a signal selected as the LOS signal, and a calculation unit configured to calculate an angular position of a wireless transmitter transmitting the signal from a phase value of a ratio of an IQ signal demodulated by the IQ demodulation unit.

According to an additional aspect of the present invention, the wireless receiver may further include a position estimation unit configured to estimate a position of the wireless receiver based on an angular position of each wireless calculated from each chirp signal transmitted by each wireless transmitter and a known installation position of each wireless transmitter.

The positioning system according to an additional aspect of the present invention may further include a third wireless transmitter configured to sequentially drive a plurality of transmit antennas arranged at regular intervals according to an arrangement order thereof to transmit the same third chirp signals.

In this instance, the position estimation unit may estimate a three-dimensional (3D) position of the wireless receiver based on an angular position of the first wireless transmitter, an angular position of the second wireless transmitter, and an angular position of the third wireless transmitter calculated by the calculation unit, and a known installation position of each wireless transmitter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an example in which a signal transmitted by a transmitter is received by a receiver through multiple paths;

FIG. 2 illustrates a concept of estimating an LOS path from signals obtained by receiving a chirp signal transmitted by the transmitter through multiple paths;

FIG. 3 illustrates a concept of a positioning system of the present invention two-dimensionally determining a position from signals received from two transmitters;

FIG. 4 is a block diagram illustrating a configuration of the positioning system of the present invention;

FIG. 5 illustrates a configuration of a wireless transmitter of the positioning system according to an aspect of the present invention;

FIG. 6 is a block diagram illustrating a configuration of a wireless receiver of the positioning system according to an aspect of the present invention; and

FIG. 7 is a block diagram illustrating a detailed configuration of a calculation unit included in the wireless receiver of the present invention.

### DETAILED DESCRIPTION OF THE INVENTION

The above-described and additional aspects are concretized through embodiments described with reference to the attached drawings. It is understood that components of each embodiment may be variously combined in an embodiment unless stated otherwise or contradicted. Each block in a block diagram may represent a physical component in some cases, but may be a logical representation of a portion of a function of a single physical component or a function across a plurality of physical components in other cases. Sometimes a substance of a block or a portion thereof may be a set of program instructions. These blocks may be implemented entirely or partially by hardware, software, or a combination thereof.

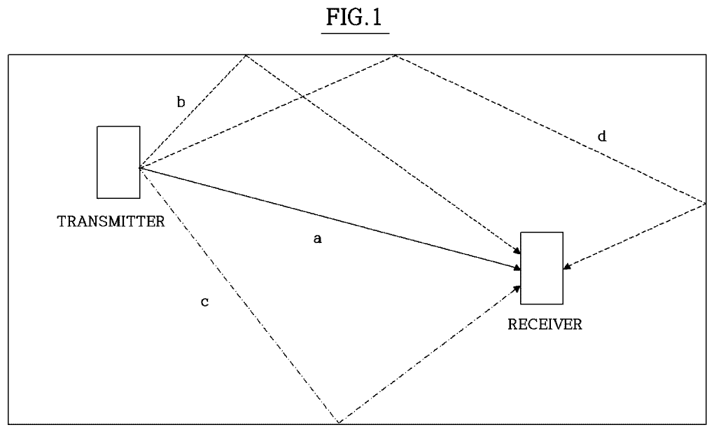

FIG. 1 illustrates an example in which a signal transmitted by a transmitter is received by a receiver through multiple paths. A radio signal transmitted by the transmitter is received by the receiver through the shortest path, such as path a, that is, an LOS path, and is received by the receiver in an overlapping manner through NLOS paths (path b, path c, and path d). When an angle (departure angle) for positioning is estimated using signals received by the receiver through multiple paths in this way, accuracy decreases.

Positioning accuracy may be improved by selecting a path a signal from among signals received through multiple paths (path a, path b, path c, and path d) by the receiver, and estimating a signal departure angle using the corresponding signal.

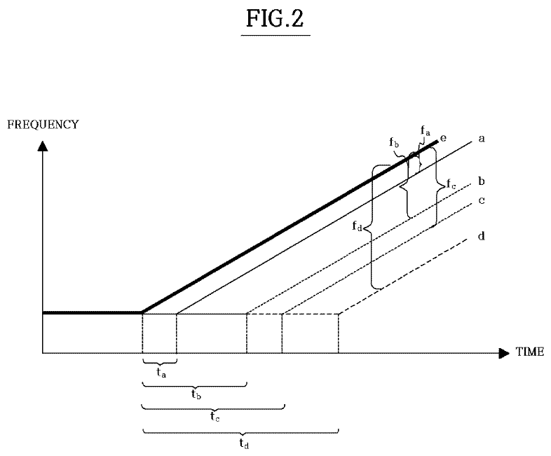

FIG. 2 illustrates a concept of estimating an LOS path from signals obtained by receiving a chirp signal transmitted by the transmitter through multiple paths. Signals illustrated in FIG. 2 are chirp signals a, b, c, and d received through multiple paths illustrated in FIG. 1 and a local oscillation signal generated by the received. The illustrated local oscillation signal e is the same chirp signal or ramp signal synchronized with the transmitter, and the receiver may theoretically detect beat frequencies fₐ. f_{b}, f_{c}, and f_{d} obtained by mixing with each received chirp signal and using a difference therebetween.

The receiver may analyze frequency components of signals modulated through mixing, and select and utilize a signal fa having the lowest frequency among frequency components of a certain size or more, thereby estimating a signal passing through a closest path (a signal having a smallest time difference) as an LOS path signal.

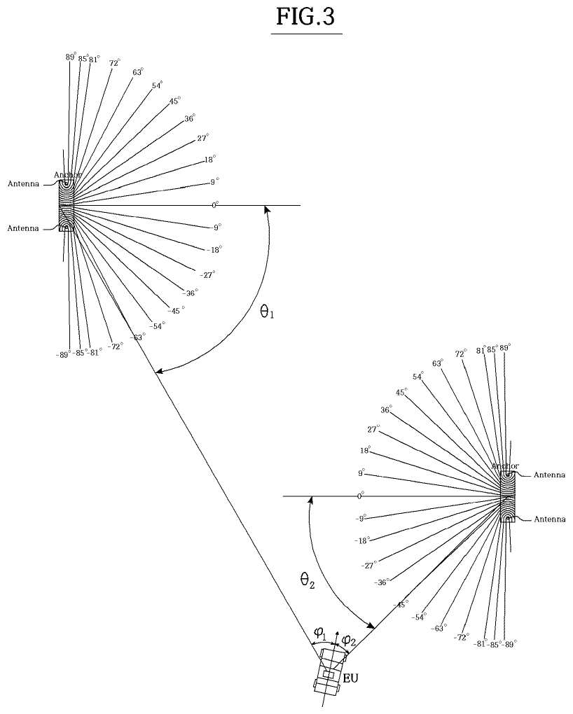

FIG. 3 illustrates a concept of a positioning system of the present invention two-dimensionally determining a position from signals received from two transmitters. As illustrated in FIG. 3, the receiver determines a position thereof using estimated departure angles of signals received from two transmitters. That is, the receiver may use a departure angle θ₁ estimated from an LOS path signal received from a first transmitter and a departure angle θ₂ estimated from an LOS path signal received from a second transmitter to two-dimensionally estimate, as the position of the receiver, a point at which a line extending in a direction of θ₁ on a two-dimensional (2D) plane from the first transmitter, whose installation position is known, intersects a line extending in a direction of θ₂ on a 2D plane from the second transmitter, whose installation position is known.

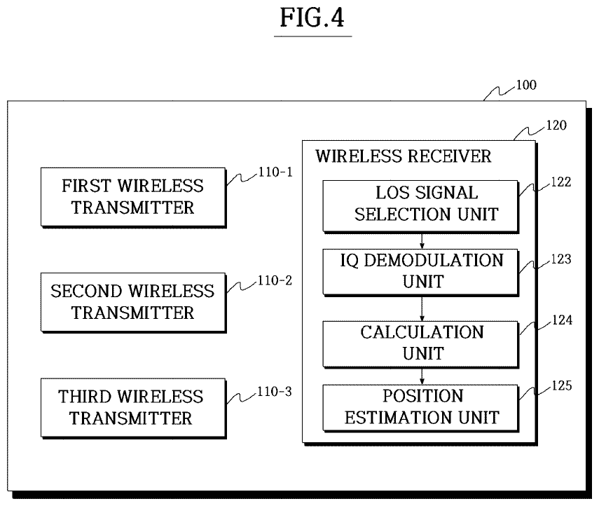

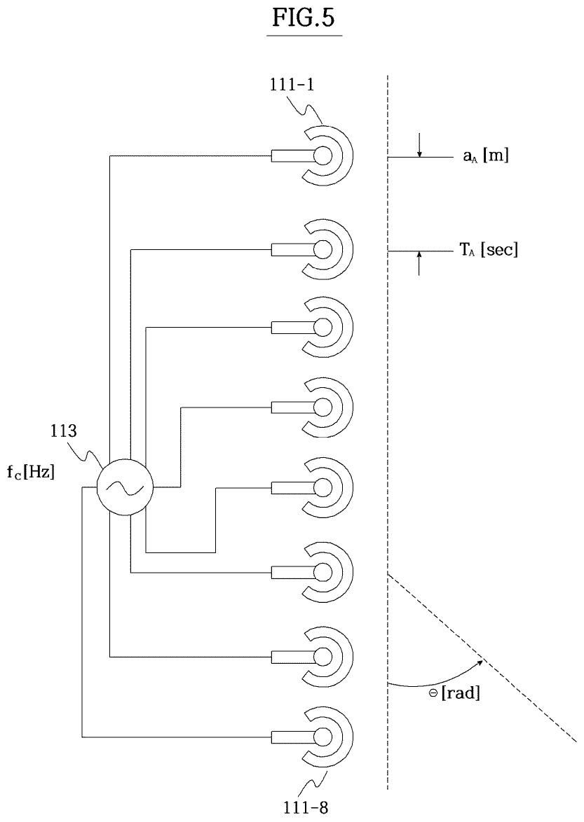

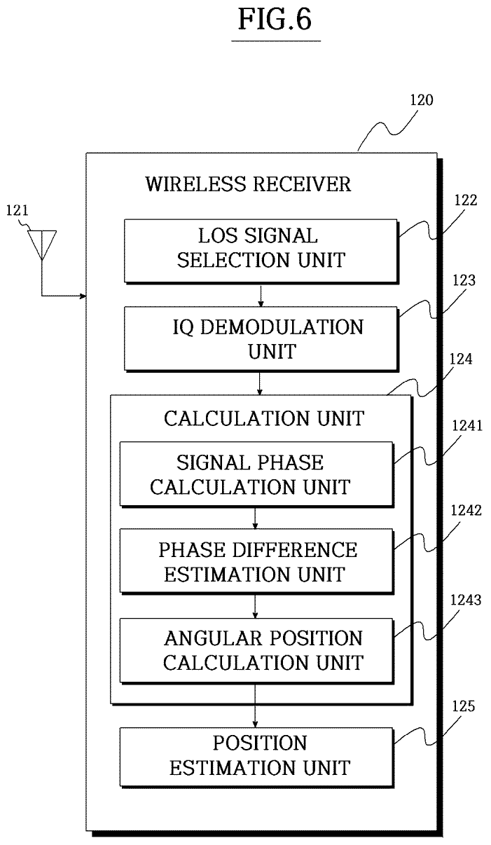

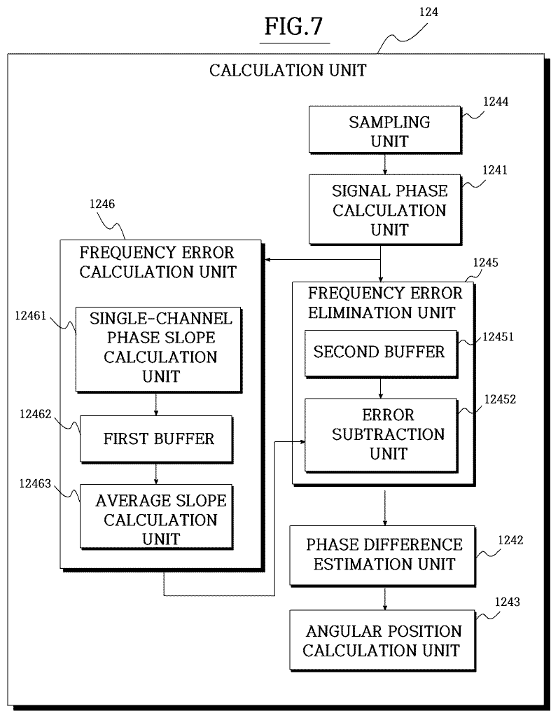

FIG. 4 is a block diagram illustrating a configuration of the positioning system of the present invention, FIG. 5 illustrates a configuration of a wireless transmitter of the positioning system according to an aspect of the present invention, FIG. 6 is a block diagram illustrating a configuration of a wireless receiver of the positioning system according to an aspect of the present invention, and FIG. 7 is a block diagram illustrating a detailed configuration of a calculation unit included in the wireless receiver of the present invention.

The positioning system 100 according to the aspect of the present invention is a system for determining a position in a multipath environment using a chirp signal, and includes a first wireless transmitter 110-1, a second wireless transmitter 110-2, and a wireless receiver 120.

As illustrated in FIG. 5, the first wireless transmitter has a plurality of transmit antennas 111-1, . . . , 111-8 arranged at regular intervals, and sequentially drives the plurality of transmit antennas 111-1, . . . , 111-8 according to an arrangement order, while transmitting the same first chirp signal. The second wireless transmitter 110-2 has the same structure as that of the first wireless transmitter 110-1 and transmits a second chirp signal.

A first chirp signal and a second chirp signal transmitted by the first wireless transmitter 110-1 and the second wireless transmitter 110-2 may be identical chirp signals whose transmission times are different from each other or chirp having signals different start frequencies.

In the illustrated example, eight transmit antennas are illustrated. However, two transmit antennas or a larger number of transmit antennas may be implemented.

The wireless receiver 120 includes an LOS signal selection unit 122, an IQ demodulation unit 123, and a calculation unit 124.

The LOS signal selection unit 122 selects an LOS signal based on a beat frequency of each path detected by processing signals of a multipath environment received through the receive antenna. That is, the LOS signal selection unit 122 analyzes frequency components of signals modulated by mixing the signals of the multipath environment received through the receive antenna with a chirp signal or a ramp signal generated by a local oscillator, and selects a signal having the lowest frequency from among frequency components having a certain size or more as an LOS signal.

The IQ demodulation unit 123 IQ-demodulates the signal selected as the LOS signal.

The calculation unit 124 calculates an angular position from the wireless transmitters 110-1 and 110-2 from a phase value of an IQ signal demodulated by the IQ demodulation unit 123. The calculation unit 124 may be implemented as software in a digital signal processor, for example. As another example, the calculation unit 124 may be implemented by including dedicated hardware, for example, an FPGA (Field Programmable Gate Array) and a microprocessor.

To easily describe a process of estimating an angular position, a description will be given on the assumption that signals transmitted by the first wireless transmitter 110-1 and the second wireless transmitter 110-2 are sine waves.

A frequency of a signal transmitted by the wireless transmitter is set to fc [Hz], a wavelength of a transmission wave is set to λc [m], an interval between transmit antennas, that is, a channel interval of a transmit antenna switching module is set to aA [m], and a channel time of the transmit antenna switching module is set to TA [sec]. When an angular position between the transmit antenna and the receive antenna is set to θ [rad], a signal S(t) received from the receive antenna of the wireless receiver may be expressed as in Equation 1.

$$S ( t ) = G ( t ) cos \{ 2 π ( {f}_{c} - {f}_{e} ) t - {φ}_{e} - m {φ}_{A} \} \qquad [ Equation 1 ]$$

Here, G(t) denotes gain between the transmitter and the receiver, fₑ denotes a local oscillation frequency error between the transmitter and the receiver, φₑ denotes a local phase oscillation difference between the transmitter and the receiver, m denotes an antenna switching module channel number (m∈[0, M−1]), and φ_{A} denotes a transmission wave phase difference

$${φ}_{A} = 2 π \frac{{a}_{A} cos θ}{{λ}_{c}}$$

between antenna switching module channels at a receiver position.

In this instance, output of the IQ demodulation unit 123 may be expressed as in Equation 2. For example, LPF[ ] is a low-pass filter having a passband of [0, f_{c}/2].

$$\begin{matrix}\{ \begin{matrix}I ( t ) \\ Q ( t )\end{matrix} = \{ \begin{matrix}LPF [ S ( t ) {i}_{LO} ( t ) ] \\ LPF [ S ( t ) {q}_{LO} ( t ) ]\end{matrix} \\ = \{ \begin{matrix}LPF [ G ( t ) cos 2 π {f}_{c} t cos \{ 2 π ( {f}_{c} - {f}_{e} ) t - {φ}_{e} - m {φ}_{A} \} ] \\ LPF [ G ( t ) sin 2 π {f}_{c} t cos \{ 2 π ( {f}_{c} - {f}_{e} ) t - {φ}_{e} - m {φ}_{A} \} ]\end{matrix} \\ = \{ \begin{matrix}LPF [ \frac{1}{2} G ( t ) \{ cos ( 2 π ( 2 {f}_{c} - {f}_{e} ) t - {φ}_{e} - m {φ}_{4} ) + cos \{ 2 π {f}_{e} t + {φ}_{e} + m {φ}_{A} \} ] \\ LPF [ \frac{1}{2} G ( t ) \{ sin ( 2 π ( 2 {f}_{c} - {f}_{e} ) t - {φ}_{e} - m {φ}_{4} ) + sin \{ 2 π {f}_{e} t + {φ}_{e} + m {φ}_{A} \} ]\end{matrix} \\ = \{ \begin{matrix}\frac{1}{2} G ( t ) cos ( 2 π {f}_{e} t + {φ}_{e} + m {φ}_{A} ) \\ \frac{1}{2} G ( t ) sin ( 2 π {f}_{e} t + {φ}_{e} + m {φ}_{A} )\end{matrix}\end{matrix} \qquad [ Equation 2 ]$$

From I(t) and Q(t), phase information 2πfₑt+φₑ+mφ_{A} not affected by the gain G(t) between the transmitter and the receiver may be obtained as in Equation 3.

$$( 2 π {f}_{e} t + {φ}_{e} + m {φ}_{A} ) = {tan}^{- 1} \frac{Q ( t )}{I ( t )} , however G ( t ) \neq 0 \qquad [ Equation 3 ]$$

Here, the local oscillation frequency error fₑ between the transmitter and the receiver and the phase difference φₑ thereof may be measured by the wireless receiver 120 using a synchronization pulse transmitted by the wireless transmitter. A method of eliminating periodicity will be described later. In this way, when a phase difference value φₑ is eliminated, a phase difference φ_{A} may be obtained by eliminating periodicity of a tangent function, which is a periodic function, from an inverse tangent function value of a ratio of a demodulated IQ signal. The local oscillation frequency error fₑ between the transmitter and the receiver may be measured using a precision measurement instrument during manufacture of the wireless transmitter and wireless receiver. For example, the phase difference φₑ may be measured by the wireless receiver 120 using a synchronization pulse transmitted from the wireless transmitter. A method of eliminating periodicity will be described later. In this way, a phase difference value mφ_{A} may be obtained, and an angular position estimate may be obtained from the value as in Equation 4.

$${φ}_{A} = 2 π {a}_{A} cos θ / {λ}_{c} , θ = {cos}^{- 1} \frac{{Q}_{A} {λ}_{c}}{2 π {a}_{A}} \qquad [ Equation 4 ]$$

Specifically, the calculation unit 124 may calculate a phase sample value from a phase value of a ratio of the IQ signal, and estimate a phase difference value between a plurality of transmit antennas and a receive antenna from the calculated phase sample value. In addition, the calculation unit 124 may calculate an angular position of the wireless receiver from the wireless transmitter transmitting the corresponding signal, that is, a departure angle of the corresponding signal, from the estimated phase difference value.

The calculation unit 124 calculates a phase sample value from an inverse tangent function value of a ratio of an IQ signal when calculating a phase sample value, and may calculate the phase sample value by correcting a function period by adding or subtracting 2π according to an increase or decrease state of the phase sample value.

Specifically, referring to FIG. 6, the calculation unit 124 may include a signal phase calculation unit 1241, a phase difference estimation unit 1242, and an angular position calculation unit 1243. All or some of the respective blocks of the calculation unit 124 illustrated in FIG. 6 may be implemented as program commands executed by a microprocessor or a digital signal processor, and may be stored as an executable file in an internal memory.

The signal phase calculation unit 1241 calculates a phase sample value from a phase value of a ratio of the IQ signal. The signals I(t) and Q(t) output from the IQ demodulation unit 123 are sampled at a sampling period T_{S} by a sampling unit 1244. The signal phase calculation unit 1241 calculates a phase sample value ϕ[n] from two sampled signals as in Equation 5. Here, the phase sample value is an inverse tangent value of the ratio of the IQ signal.

$$ϕ [ n ] = {tan}^{- 1} \frac{Q ( {nT}_{s} )}{1 ( {nT}_{s} )} \qquad [ Equation 5 ]$$

Here, n denotes a sample index. In actual implementation, a function atan 2( ) is used to obtain a phase value of an IQ signal vector in a range (−π, π]. This function takes relative coordinates of two points as input and calculates and outputs a phase angle of the vector in the range (−π, π].

It is possible to compensate for a periodic phase sample value obtained by an inverse tangent function to obtain an absolute phase value. The signal phase calculation unit 1241 calculates and outputs a phase sample value obtained by compensating for a function period by adding or subtracting 2π to or from a phase sample value obtained by a function atan 2( ) according to an increase or decrease state thereof. The function atan 2( ) has a value only in a range of (−π, π], and thus compensation is performed to obtain an absolute phase value. This compensation is performed according to an increase or decrease state of two consecutive phase sample values, and may be implemented by, for example, the following algorithm.

```
  ∘ Step 1: initialize 2pi_calibration = 0
  ∘ Step 2: n = 0, ^{\tilde{ϕ}}[0] = ϕ[0]
  ∘ Step 3: if ϕ[n + 1] > ϕ[n] th en
    if {ϕ[n + 1] − ϕ[n]} > {ϕ[n] − (ϕ [n + 1] −
2π)} th en
      2pi_calibration −= 2π
      endif
    else
      if {ϕ[n] − ϕ[n + 1]} < {(ϕ[n + 1] +
2π) − ϕ[n]} th en
      2pi_calibration += 2π
    endif
  ∘ Step 4: ^{\tilde{ϕ}}[n + 1] = ϕ[n + 1] + 2pi_calibration
  ∘ Step 5: ++n, go back to Step 3 and repeat for all n
```

The phase difference estimation unit 1242 estimates phase values received by a receive antenna 121 from a plurality of transmit antennas from these phase sample values. The phase difference estimation unit 1242 calculates a phase value for each transmit antenna from the phase sample values, and estimates a phase difference value between the plurality of transmit antennas and the receive antenna from an average value of difference values of phase values between adjacent transmit antennas.

The phase difference estimation unit 1242 averages phase sample values for each transmit antenna during at least a portion of a transmit antenna switching period to calculate phase difference values for each transmit antenna. As illustrated in FIG. 5, when the transmit antenna switching period is set to T_{A}, N (N=T_{A}/T_{S}) phase sample values are acquired from a reception wave signal obtained by receiving a transmission wave transmitted from one transmit antenna during a period T_{A} according to a sampling frequency. The phase difference estimation unit 1242 may obtain M phase difference values for each transmit antenna by averaging N phase difference values.

The phase difference estimation unit 1242 may calculate a phase difference value for each transmit antenna for a section excluding a time determined based on a switching stabilization time before and after a switching period of the transmit antenna. Since signals are switched and output from a plurality of transmit antennas, the signals may be unstable for a certain time before and after switching. When a transmit antenna index is set to m by factoring in this fact, a section average value {φₘ} may be obtained by excluding an arbitrary time To before and after T_{A} for each section T_{A} for each m. Accordingly, the number of phase sample values for which an average value is obtained may be less than N.

The phase difference estimation unit 1242 calculates an average value of difference values of phase difference values between adjacent transmit antennas from phase difference values for each transmit antenna. The phase difference estimation unit 1242 buffers the calculated phase difference values for each transmit antenna for one positioning period and obtains difference values of phase difference values between adjacent transmit antennas. That is, when an antenna index is set to m, Δm=φₘ−φₘ₋₁ is calculated for all m. Thereafter, the phase difference estimation unit 1242 obtains an average of these difference values as in Equation 6.

$${\overline{Δ}}_{m} = \frac{{\sum }_{m = 1}^{M - 1} {Δ}_{m}}{M - 1} \qquad [ Equation 6 ]$$

Δ̅ₘ may be regarded as an estimate of φA.

The angular position calculation unit 1243 calculates angular positions of the wireless receiver 120 from the wireless transmitters 110-1, 110-2, and 110-3 from the estimated phase difference values. As described above, a position estimation value \tilde{θ} may be obtained from

$${φ}_{A} = 2 π \frac{{a}_{A} cos θ}{{λ}_{c}}$$

using Equation 4.

An error component between frequencies of a transmitter local oscillator 113 and a receiver local oscillator may be removed from a phase difference value for each transmit antenna. The calculation unit 124 may further include a frequency error elimination unit 1245.

The frequency error elimination unit 1245 eliminates an error component between frequencies of the transmitter local oscillator 113 and the receiver local oscillator from a phase value for each transmit antenna.

As shown in Equation 3 above, an inverse tangent value of the IQ signal includes a term 2πfₑt that is a frequency error component.

This term is a first-order function component that increases over time from the inverse tangent value of the IQ signal. For example, the frequency error component between these local oscillators may be precisely measured and accounted for during manufacture of the transmitter and the receiver. Another example may be implemented as a model that changes with temperature, centered on values measured at several temperatures. In this case, the frequency error elimination unit 1245 calculates a local oscillation frequency from an ambient temperature value of the receiver local oscillator measured using a sensor, and calculates a frequency error difference with a transmitter-side local oscillation frequency value received from the transmitter. Thereafter, a frequency error component may be calculated by multiplying a slope value, which is obtained by multiplying the difference value by 2π, by a sampling index and a sampling period TS. This frequency error component may be eliminated by subtracting this frequency error component from the phase sample value calculated by the signal phase calculation unit 1241.

According to another aspect, an error component between frequencies of the transmitter local oscillator 113 and the receiver local oscillator may be estimated from an average slope value of phase values of samples received from a plurality of transmit antennas. According to this aspect, the calculation unit 124 of the wireless receiver 120 may further include a frequency error calculation unit 1246.

The frequency error calculation unit 1246 calculates slope values of phase values received from a plurality of transmit antennas through the receive antenna from the phase sample values and multiplies the slope values by a sampling index to calculate frequency error components. As illustrated, the frequency error calculation unit 1246 may include a single-channel phase slope calculation unit 12461 and an average slope calculation unit 12463.

The single-channel phase slope calculation unit 12461 calculates a slope value for each transmit antenna by one-dimensional (1D) linear approximation of the phase sample values for each transmit antenna during at least a portion of the transmit antenna switching period. The single-channel phase slope calculation unit 12461 processes each of the phase sample values {\tilde{ϕ}[n]}ₘ received from a number m transmit antennas, and performs 1D linear approximation for all m∈[0, M−1], that is, all transmit antennas. Since 1D linear approximation of N phase sample values for each transmit antenna is conventional technology, a detailed description is omitted.

The single-channel phase slope calculation unit 12461 may calculate a slope value of a phase for each transmit antenna during a section excluding a time determined by a switching stabilization time before and after a switching period of the transmit antenna. Since RF signals are switched and output from a plurality of transmit antennas, the signals may be unstable for a certain time before and after switching. In consideration of this, when a transmit antenna index is set to m, a slope value \tilde{S}ₘ may be calculated through 1D linear approximation by excluding an arbitrary time To before and after T_{A} for each section T_{A} for each m. Accordingly, the number of phase sample values subjected to 1D linear approximation may be less than N.

Thereafter, the average slope calculation unit 12463 calculates a slope of a phase value by averaging slope values for each transmit antenna with respect to all of a plurality of transmit antennas. The average slope calculation unit 12463 needs to average slope values of phase values for all transmit antennas, and thus may further include a first buffer 12462 for storing slope values of phases for each of M transmit antennas during one positioning period.

The single-channel phase slope calculation unit 12461 may obtain a phase slope value, which is an average of slope values \tilde{S}ₘ on a signal received from one calculated transmit antenna, as in Equation 7.

$$\tilde{s} = \frac{{\sum }_{m = 0}^{M - 1} {\tilde{S}}_{m}}{M} \qquad [ Equation 7 ]$$

The phase slope value is proportional to a frequency error. Thereafter, this phase slope value may be multiplied by a sampling index n to calculate a frequency error component 2πfₑt from a phase difference.

In this illustrated example, the frequency error elimination unit 1245 includes an error subtraction unit 12452.

The error subtraction unit 12452 may subtract this frequency error component from a phase sample value as in Equation 8 to eliminate the frequency error component.

$$\tilde{ϕ} [ n ] = \tilde{ϕ} [ n ] - \overline{s} \cdot n \qquad [ Equation 8 ]$$

In this instance, the error subtraction unit 12452 may calculate a frequency error only when radio frequency signals are received from all transmit antennas during one positioning period. Accordingly, the frequency error elimination unit may include a second buffer 12451 that stores the phase sample value during one positioning period to buffer the phase sample value output from the signal phase calculation unit 1241 while calculating a frequency error value of the corresponding positioning period.

According to an additional aspect of the present invention, the wireless receiver may further include a position estimation unit 125.

The position estimation unit 125 estimates a position of the wireless receiver 120 based on an angular position of each wireless transmitter calculated from each chirp signal transmitted by each wireless transmitter and a known installation position of each wireless transmitter. That is, the position estimation unit 125 uses an angular position of the first wireless transmitter estimated from a signal transmitted by the first wireless transmitter 110-1, that is, a departure angle of the first chirp signal, and an angular position of the second wireless transmitter estimated from a signal transmitted by the second wireless transmitter 110-2, that is, a departure angle of the second chirp signal to estimate, as a position of the wireless receiver, a point at which straight lines extending at the corresponding departure angles from the first wireless transmitter 110-1 and the second wireless transmitter 110-2, whose positions are known on a 2D plane, intersect each other.

The positioning system according to an additional aspect of the present invention may further include a third wireless transmitter 110-3.

The positioning system may estimate a 2D position of the wireless receiver using two wireless transmitters, and may estimate a 3D position of the wireless receiver using three or more wireless transmitters.

Similarly to the first and second wireless transmitters 110-1 and 110-2, the third wireless transmitter 110-3 sequentially drives a plurality of transmit antennas arranged at regular intervals according to an arrangement order to transmit the same third chirp signals. The third wireless transmitter 110-3 needs to ensure that an arrangement direction of the plurality of transmit antennas is not on a plane formed by the first and second wireless transmitters 110-1 and 110-2. For convenience of position calculation, transmit antenna directions of the first wireless transmitter 110-1, the second wireless transmitter 110-2, and the third wireless transmitter 110-3 are preferably 90 degrees with respect to one another. However, the present invention is not limited thereto.

In this instance, the position estimation unit 125 may estimate a 3D position of the wireless receiver based on the angular position of the first wireless transmitter 110-1, the angular position of the second wireless transmitter 110-2, and the angular position of the third wireless transmitter 110-3 calculated by the calculation unit 124, and the known installation position of each wireless transmitter. That is, the position estimation unit 125 uses the angular position of the first wireless transmitter 110-1 estimated from the signal transmitted by the first wireless transmitter 110-1, that is, the departure angle of the first chirp signal, the angular position of the second wireless transmitter 110-2 estimated from the signal transmitted by the second wireless transmitter 110-2, that is, the departure angle of the second chirp signal, and the angular position of the third wireless transmitter 110-3 estimated from the signal transmitted by the third wireless transmitter 110-3, that is, the departure angle of the third chirp signal to estimate, as a position of the wireless receiver, a point at which planes extended at the corresponding departure angles from the first wireless transmitter 110-1, the second wireless transmitter 110-2, and the third wireless transmitter 110-3, whose positions are known in three dimensions, intersect one another.

According to the present invention, it is possible to estimate a departure angle of a signal transmitted by a transmitter in a multipath environment with high accuracy.

In addition, according to the present invention, it is possible to determine a position of a receiver using at least two transmitters in a multipath environment.

Even though the present invention has been described above through embodiments with reference to the attached drawings, the present is not limited thereto, and should be interpreted to encompass various modifications that may be obviously derived from these embodiments by those skilled in the art. The scope of the patent claims is intended to encompass such modifications.

What is claimed is:

1. A positioning system in a multipath environment using a chirp signal, the positioning system comprising:
a first wireless transmitter configured to sequentially drive a plurality of transmit antennas arranged at regular intervals according to an arrangement order thereof to transmit the same first chirp signals;
a second wireless transmitter configured to sequentially drive a plurality of transmit antennas arranged at regular intervals according to an arrangement order thereof to transmit the same second chirp signals; and
a wireless receiver comprising a line-of-sight (LOS) signal selection unit configured to select an LOS signal based on a bit frequency of each path detected by processing signals in the multipath environment received through a receive antenna, an IQ demodulation unit configured to IQ-demodulate a signal selected as the LOS signal, and a calculation unit configured to calculate an angular position of a wireless transmitter transmitting the signal from a phase value of a ratio of an IQ signal demodulated by the IQ demodulation unit.

2. The positioning system according to claim 1, wherein the wireless receiver further comprises a position estimation unit configured to estimate a position of the wireless receiver based on an angular position of each wireless transmitter calculated from each chirp signal transmitted by each wireless transmitter and a known installation position of each wireless transmitter.

3. The positioning system according to claim 2, further comprising a third wireless transmitter configured to sequentially drive a plurality of transmit antennas arranged at regular intervals according to an arrangement order thereof to transmit the same third chirp signals,
wherein the position estimation unit estimates a three-dimensional (3D) position of the wireless receiver based on an angular position of the first wireless transmitter, an angular position of the second wireless transmitter, and an angular position of the third wireless transmitter calculated by the calculation unit, and a known installation position of each wireless transmitter.

4. The positioning system according to claim 1, wherein the calculation unit calculates phase sample values from the phase value of the ratio of the IQ signal, estimates a phase difference value between a plurality of transmit antennas and the receive antenna from the calculated phase sample values, and calculates an angular position of the wireless receiver from each wireless transmitter from the estimated phase difference value.

5. The positioning system according to claim 4, wherein, when calculating the phase sample values, the calculation unit calculates the phase sample values from an inverse tangent function value of the ratio of the IQ signal, and calculates the phase sample values obtained by correcting a function period by adding or subtracting 2n according to an increase or decrease state of the phase sample values.

6. A wireless receiver configured to determine a position in a multipath environment using a chirp signal, the wireless receiver comprising:
a receive antenna configured to receive the same chirp signals sequentially transmitted from a plurality of transmit antennas arranged at regular intervals;
an LOS signal selection unit configured to select an LOS signal based on a bit frequency of each path detected by processing signals in the multipath environment received through the receive antenna;
an IQ demodulation unit configured to IQ-demodulate a signal selected as the LOS signal; and
a calculation unit configured to calculate an angular position of a wireless transmitter transmitting the signal from a phase value of a ratio of an IQ signal demodulated by the IQ demodulation unit.

7. The wireless receiver according to claim 6,
further comprising a position estimation unit configured to estimate a position of the wireless receiver based on an angular position of each wireless transmitter calculated from each of chirp signals transmitted by two or three wireless transmitters and a known installation position of each wireless transmitter.

8. The wireless receiver according to claim 6, wherein the calculation unit comprises a signal phase calculation unit configured to calculate phase sample values from a phase value of a ratio of an IQ signal, a phase difference estimation unit configured to estimate a phase difference value between a plurality of transmit antennas and a receive antenna from the calculated phase sample values, and an angular position calculation unit configured to calculate an angular position of the wireless receiver from each wireless transmitter from the estimated phase difference value.

9. The wireless receiver according to claim 8, wherein the phase difference estimation unit comprises a function value calculation unit configured to calculate the phase sample values from an inverse tangent function value of the ratio of the IQ signal, and a function period correction unit configured to calculate the phase sample values obtained by correcting a function period by adding or subtracting 2π according to an increase or decrease state of the phase sample values.
